(19) United States
(12) Patent Application Publication
(10) Pub. No.: US 2014/0301901 A1
(43) Pub. Date: Oct. 9, 2014

(54) PHOTOREACTIVE SYSTEM FOR PRESERVING PRODUCE

(71) Applicant: Biological Illumination, LLC, Satellite Beach, FL (US)

(72) Inventors: Fredric S. Maxik, Indialantic, FL (US); David E. Bartine, Cocoa, FL (US); Robert R. Soler, Cocoa Beach, FL (US)

(73) Assignee: Biological Illumination, LLC, Satellite Beach, FL (US)

(21) Appl. No.: 14/211,663

(22) Filed: Mar. 14, 2014

Related U.S. Application Data
(60) Provisional application No. 61/792,656, filed on Mar. 15, 2013.

(51) Int. Cl. A23B 7/159; A23B 7/015

(52) U.S. Cl. CPC A23B 7/159; A23B 7/015
USPC 422/119; 422/186; 422/186.3

(57) ABSTRACT

A photoreactive system for preserving produce is provided. The photoreactive system may include a body member including an outer wall, an inner wall, a proximal vented section, a distal vented section, a void between an inner surface of the outer wall and an outer surface of the inner wall defined as an outer chamber, and a void defined by an inner surface of the inner wall defined as an inner chamber, a light source configured to emit light within a wavelength range and a plurality of photoreactive pellets configured to react to the light emitted by the light source to remove at least one of bacteria, volatile organic compounds (VOCs), and ethylene. The plurality of photoreactive pellets may be positioned within the outer chamber. The light source may be positioned within the inner chamber. The proximal and distal vented sections may be configured to permit a gaseous flow therethrough.

### RELATED APPLICATIONS

This application claims the benefit under 35 U.S.C. §119(e) of U.S. Provisional Patent Application Ser. No. 61/792,656 filed on Mar. 15, 2013 and titled Photoreactive System for Preserving Produce, the entire contents of which is incorporated herein by reference.

### FIELD OF THE INVENTION

The present invention relates to systems and methods for removing spoiling substances from a contained environment.

### BACKGROUND

The presence of bacteria, volatile organic compounds (VOCs), or ethylene in a contained volume, such as a refrigerated volume, within which produce is stored serves to accelerate the degredation and decay of the produce, thereby rendering the produce less favorable for consumption at an accordingly accelerated rate. Therefore, removal of bacteria, VOCs, and ethylene from such contained volumes will increase the duration for which produce remains favorable for consumption. Accordingly, there is a need in the art for a system capable of removing bacteria, VOCs, and ethylene from a gaseous fluid that may occupy a contained volume within which produce may be stored.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to a photoreactive system comprising a body member, the body member including an outer wall, an inner wall, a proximal vented section, a distal vented section, a void between an inner surface of the outer wall and an outer surface of the inner wall defined as an outer chamber, and a void defined by an inner surface of the inner wall defined as an inner chamber. The photoreactive system may further comprise a light source configured to emit light within a wavelength range and a plurality of photoreactive pellets configured to react to the light emitted by the light source to remove at least one of bacteria, volatile organic compounds (VOCs), and ethylene. The plurality of photoreactive pellets may be positioned within the outer chamber. Additionally, the light source may be positioned within the inner chamber. Furthermore, the proximal and distal vented sections may be configured to permit a gaseous flow therethrough, the gaseous flow including at least one of bacteria, VOCs, and ethylene.

In some embodiments, the light source may be configured to emit light within a wavelength range from about 10 nm to about 400 nm. Additionally, in some embodiments, the plurality of photoreactive pellets may include pellets configured to react to light within a wavelength range of at least one of from about 320 nm to about 400 nm, from about 290 nm to about 320 nm, and from about 200 nm to about 290 nm. In some embodiments, the plurality of photoreactive pellets may include pellets made from at least one of titanium dioxide and silicon dioxide. Additionally, the plurality of photoreactive pellets may include a mixture of pellets formed of titanium dioxide and pellets formed of silicon dioxide. The photoreactive pellets formed of titanium dioxide may be one of interspersed, segregated longitudinally, and segregated so as to form respective semicircles with the photoreactive pellets formed of silicon dioxide.

The light source may be generally coextensive with a length of the plurality of photoreactive pellets. Furthermore, the light source may comprise a plurality of light-emitting diodes (LEDs). The plurality of LEDs may be distributed so as to emit light in an approximately 360 degree distribution along the length of the light source.

The photoreactive system according to embodiments of the present invention may further comprise a drain in fluid communication with the outer chamber. The photoreactive system may further comprise a retaining member configured to retain the plurality of photoreactive pellets within the outer chamber.

The photoreactive system according to embodiments of the present invention may further comprise a fluid flow generator positioned in fluid communication with the proximal vented section; wherein the fluid flow generator is positioned such that a fluid flow generated thereby causes a fluid flow through the outer chamber.

The photoreactive system may further comprise a sensor configured to provide information related to the environment within a refrigerated volume associated with the photoreactive system. Additionally, the light source may comprise a controller device positioned in electrical communication with the sensor. The controller device may be configured to control operation of the light source responsive to information received from the sensor. Furthermore, the plurality of photoreactive pellets may include pellets configured to react to light emitted by generating carbon dioxide. The sensor may be configured to provide information related to the level of carbon dioxide within the refrigerated volume. Additionally, the controller device may be configured to operate the light source to cause the generation of carbon dioxide responsive to the level of carbon dioxide indicated from the sensor.

### BRIEF DESCRIPTION OF THE DRAWINGS

FIG. 1 is a perspective sectional view of an embodiments of the invention

FIG. 2 is a side sectional view of the embodiment of the invention depicted in FIG. 1.

FIG. 3 is a side sectional view of the embodiment of the invention depicted in FIG. 1 further comprising a fluid flow generator.

FIG. 4 is a schematic view of an embodiment of the invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides a system for eliminating spoiling substances from an environment of a contained system. More specifically, a system for reducing bacterial count and removing both volatile organic compounds and ethylene from a contained system, such as a refrigeration system.

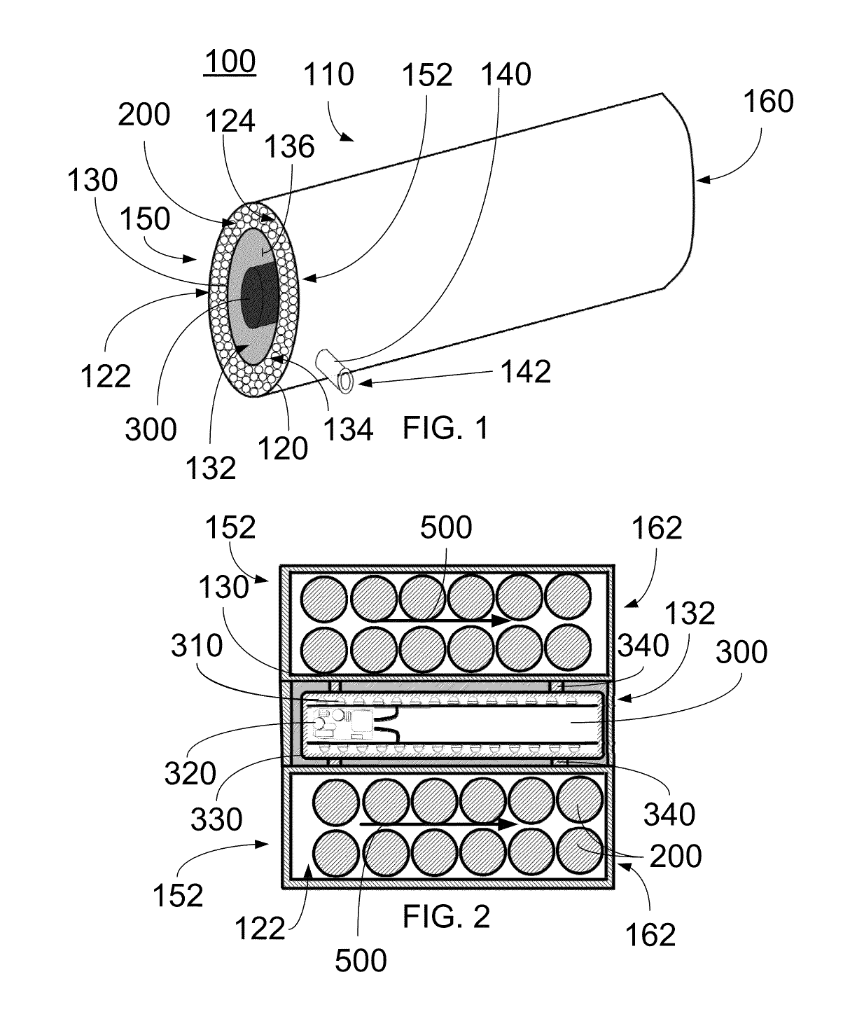

Referring now to FIG. 1, aspects of the invention will now be discussed. The present embodiment of the invention may be a photoreactive system 100 including a tubular body member 110, a plurality of photoreactive pellets 200, and light source 300. The tubular body member 110 may be configured to include an outer wall 120 and an inner wall 130. The outer wall 120 may positioned so as to be co-extensive with and generally cover the inner wall 130. Furthermore, each of the outer wall 120 and the inner wall 130 may be formed in any suitable geometry. Moreover, the outer wall 120 and the inner wall 130 may be formed to substantially the same geometric shape. In the present embodiments, the outer wall 120 and the inner wall 130 are generally circular. In other embodiments, each of the outer wall 120 and the inner wall 130 may be formed into generally ovular, elliptical, triangular, rectangular, square, or any other polygonal configuration.

The body member 110 may further include an outer chamber 122 and inner chamber 132. The outer chamber 122 may be defined as a void between an inner surface 124 of the outer wall 120 and an outer surface 134 of the inner wall 130. The inner chamber 132 may be defined as a void generally surrounded by an inner surface 136 of the inner wall 130.

The body member 110 may further include a proximal end 150 and a distal end 160. Each of the proximal end 150 and the distal end 160 may include a vented section 152, 162 (as seen in FIG. 2). The vented sections 152, 162 may be configured to permit fluid flow therethrough. Moreover, the vented sections 152, 162 may be configured to place the outer chamber 122 in fluid communication with the environment surrounding the vented sections 152, 162. The vented section 152, 162 may include a retaining member configured to retain the plurality of photoreactive pellets 200 within the outer chamber 122 and prevent them from spilling out of the outer chamber 122 while still permitting fluid flow therethrough. In some embodiments, the retaining member may be a mesh structure. In some other embodiments, the retaining member may be a generally flat structure having a plurality of holes formed therein, wherein the diameter of the holes is less than a diameter of the plurality of pellets 200.

Additionally, in some embodiments, the body member 110 may further include a drain 140. The drain may be configured to be in fluid communication with the outer chamber 122. Furthermore, the drain 140 may be positioned such that any fluid that collects in the outer chamber 122 may flow through the drain 140. Additionally, the drain 140 may include an exit portal 142 that may desirously direct fluid away from the photoreactive system 100.

Continuing to refer to FIG. 1, the plurality of photoreactive pellets 200 will now be discussed in greater detail. The plurality of photoreactive pellets 200 may be generally granular structures of material. Moreover, the material forming the plurality of photoreactive pellets 200 may selected so as to be photoreactive. Furthermore, the material forming the plurality of photoreactive pellets 200 may be selected so that, when irradiated with light within a certain wavelength range, the photoreactive pellets 200 may remove spoiling materials from the environment within the outer chamber. For example, the plurality of photoreactive pellets 200 may be formed of a photoreactive material that, when bombarded with light within the wavelength range of from about 10 nanometers (nm) to about 400 nm, remove at least one of bacteria, VOCs, and ethylene from the environment surrounding the photoreactive pellets 200. The above-mentioned types of materials that the plurality of photoreactive pellets 200 may remove from the surrounding environment is exemplary only and does not limit the scope of the invention. Furthermore, in some embodiments, the plurality of photoreactive pellets 200 may be formed of a photoreactive material that reacts to sections of wavelengths within the UV spectrum. For example, the photoreactive pellets 200 may react to light having a wavelength within the range from about 320 nm to about 400 nm, commonly referred to as the UVA range, from about 290 nm to about 320 nm, commonly referred to as the UVB range, and from about 200 nm to about 290 nm, commonly referred to as the UVC range.

In some embodiments, some of the plurality of photoreactive pellets 200 may be formed of titanium dioxide. In other embodiments, some of the plurality of photoreactive pellets 200 may be formed of silicon dioxide. In some other embodiments, the plurality of photoreactive pellets may include a mixture of pellets formed of silicon dioxide and pellets formed of titanium dioxide. Where the plurality of photoreactive pellets 200 are include a mixture of pellets formed of different materials, the pellets formed of the respective materials may be mixed and interspersed through the length of the outer chamber 122, may be segregated longitudinally, or may be segregated so as to form respective semicircles.

Continuing to refer to FIG. 1, the light source 300 will now be discussed in greater detail. The light source 300 may be configured to emit light. More specifically, the light source 300 may be a lighting device configured to emit light within a wavelength range to which the plurality of photoreactive pellets 200 may react. In some embodiments, the light source 300 may be configured to emit light within the UV spectrum. In some further examples, the light source 300 may be configured to emit light within the UVA range, the UVB range, and/or the UVC range.

The light source 300 may include any type of lighting device that may emit light within a wavelength range to which the photoreactive pellets 200 may react. Types of lighting devices include, without limitation, light-emitting semiconductors, such as light-emitting diodes (LEDs), incandescents, halogens, fluorescents, and arc-lights. These types of lighting devices are exemplary only and the scope of the invention is not limited to or by them.

The light source 300 may be positioned within the internal chamber 132. Moreover, in some embodiments, the light source 300 may be configured to extend through the length of the internal chamber 132. Furthermore, the light source 300 may be configured to extend through a length of the internal chamber 132 for a length that is generally coextensive with a length the plurality of photoreactive pellets 200 extend through the outer chamber 122.

Referring now to FIG. 2, the light source 300 will be discussed in further detail. In some embodiments, the light source 300 may be configured to be tubular in shape. Moreover, in some embodiments, the light source may be configured so as to emit light substantially about the light source 300, for instance, in a 360-degree distribution about the light source 300. For example, in the present embodiment, the light source 300 may include a plurality of LEDs 310 distributed substantially about a periphery of the light source 300. Moreover, the plurality of LEDs 310 may be distributed about the periphery such that the light emitted by the plurality of LEDs 310 collectively is distributed substantially about the light source 300 in an approximately 360-degree distribution along the length of the light source 300. Furthermore, where the light source 300 comprises a plurality of LEDs 310, the light source 300 may further include a driver circuit 320. The driver circuit 320 may be electrically coupled to the plurality of LEDs 310 and be configured to control the operation of the plurality of LEDs 310. Furthermore, the driver circuit 320 may be configured to be placed in electrical communication with a power source (not shown) through the connection of electrical connectors (not shown) to the driver circuit 320. The driver circuit 320 may include circuitry configured to condition power received from the power source to a current and voltage suitable for operating the plurality of LEDs 310.

The light source 300 may further include an optic 330. The optic 330 may be positioned to generally surround the light-emitting elements of the light source 300, such as, as in the embodiment depicted in FIG. 2, the plurality of LEDs 310. The optic 330 may be formed of a transparent material, such as those recited hereinabove, to permit light emitted by the light source 300 to propagate through to the plurality of photoreactive pellets 200. Additionally, in some embodiments, the optic 330 may be configured to refract light emitted by the light source 300 so as to facilitate the uniform distribution of light about the light source 300.

The light source 300 may be suspended in the inner chamber 132, supported by a plurality of struts 340. The plurality of struts 340 may be configured to carry the light source 300 at a position in the inner chamber 132 that facilitates uniform distribution of light emitted by the light source 300 to the plurality of photoreactive pellets 200. More specifically, the plurality of struts 340 may position the light source 300 such that a longitudinal axis of the light source 300 is collinear with a longitudinal axis of the inner chamber 132.

As recited hereinabove, the light emitted by the light source 300 must be incident upon the plurality of photoreactive pellets 200 so that the pellets may react. Accordingly, the inner wall 130 may be formed of a material that is generally transparent. Furthermore, in some embodiments, the inner wall 130 may be formed of a material that is generally transparent to light within a wavelength range that corresponds to a wavelength range that the plurality of photoreactive pellets 200 may react to. For example, the inner wall 130 may be formed of plastic, glass, polycarbonate, or any other transparent polymer.

Continuing to refer to FIG. 2, the function of the photoreactive system 100 will now be discussed in detail. As recited hereinabove, the photoreactive system 100 may be included as part of a broader refrigeration system. Most refrigeration systems rely on the exchange of heat between a refrigerant and gas in the ambient environment of the refrigerated volume. In order to facilitate the distribution of the cooled air from the area surrounding the area where the heat exchange occurs, an air handling system is usually employed. As such, the photoreactive system 100 may be integrated into an air handling system of the refrigerator system.

The air handling system of the refrigerator system may create a fluid flow 500 through the photoreactive system 100. More specifically, the fluid flow 500 may be the flow of the gas of the refrigerated volume through the outer chamber 122. As described hereinabove, the vented sections 152, 162 may place the outer chamber 122 in fluid communication with the fluid flow 500. More specifically, the fluid flow 500 may enter the outer chamber 122 through the proximal vented section 152 and exit through the distal vented section 162. The fluid flow 500 may be comprised of gas from the refrigerated volume. The gas may include at least one of bacteria, VOCs, and ethylene.

While the fluid flow 500 is flowing through the outer chamber 122, the light source 300 may be emitting light and irradiating the plurality of photoreactive pellets 200. As the fluid flow 500 progresses through the outer chamber 122, the bacteria, VOCs, and ethylene may come into contact with the plurality of photoreactive pellets 200. Where one of the bacteria, VOC, and ethylene, collectively referred to as a toxin, comes into contact with one of the plurality of photoreactive pellets 200 being irradiated by light within the wavelength range to which the pellet will react, the toxin may undergo a chemical reaction that removes the toxin from the fluid flow 500. The removal of the toxin may be desirable in a number of scenarios, such as, for example, where foodstuffs are contained within the refrigerated volume.

As is known in the art, a common byproduct of the chemical reaction recited hereinabove is carbon dioxide. The carbon dioxide may mix with the gas comprising the fluid flow 500 and exit the outer chamber 122 through the distal vented section 162. The fluid flow 500 may then return to the refrigerated volume.

In some embodiments, the carbon dioxide may desirously enter the fluid flow 500. For example, where foodstuffs are contained within the refrigerated volume, the carbon dioxide may serve to have a preserving effect on the foodstuffs. Accordingly, in some embodiments, the photoreactive system 100 may be configured such that a maximum amount of the carbon dioxide generated by the removal of the toxin from the fluid flow 500 by the photoreactive pellets 200 is introduced to the fluid flow 500 and returned to the refrigerated volume. Additionally, as another example, a refrigeration system may be used to reduce the temperature of a volume where plants are being cultivated. Where the plants perform photosynthesis, an environment containing a sufficient level of carbon dioxide is required. Accordingly, a photoreactive system 100 that generates carbon dioxide may be positioned and operates so as to provide the necessary carbon dioxide for the plants.

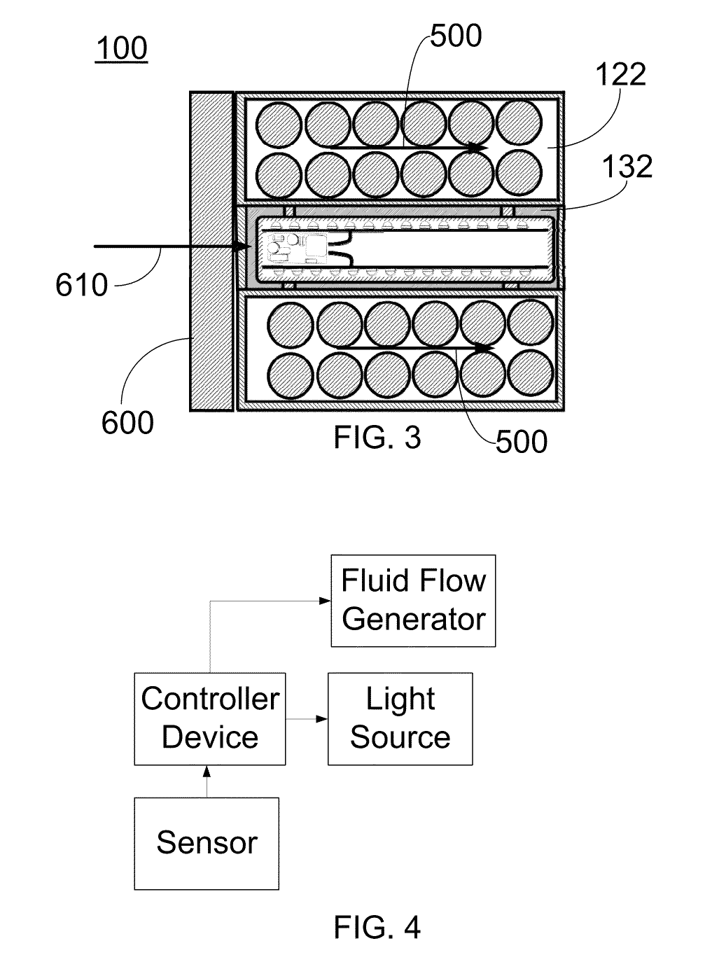

In some embodiments, the photoreactive system 100 may not be positioned such that the fluid flow generated by the air handling system of the refrigeration system flows through the outer chamber 122. In such embodiments, the fluid flow 500 may be generated by a fluid flow generator 600, as depicted in FIG. 3. The fluid flow generator may be any device capable of generating a fluid flow sufficient to cause gas from the refrigerated volume to flow through the outer chamber 122. Examples of such devices may include, for example, a fan and an ionic wind generator. Furthermore, an additional example of such a device may be found in U.S. patent application Ser. No. 13/107,782 titled Sound Baffling Cooling System for LED Thermal Management and Associate Methods filed May 13, 2011, the content of which is incorporated by reference herein in its entirety.

For example, continuing to refer to FIG. 3, a fluid flow generator 600 is presented. The fluid flow generator may be positioned generally proximally to the proximal end 150 of the body member 110. Moreover, the fluid flow generator 600 may be positioned such that the fluid flow 610 generated by the fluid flow generator 600 enters the outer chamber 122 through the proximal vented section 152 as described hereinabove.

Furthermore, in some embodiments, the fluid flow generator 600 may generate a fluid flow 610 through the inner chamber 132 that may facilitate the dissipation of heat generated by heat-generating elements of the light source 300, such as, for example, the plurality of LEDs 310 and the driver circuit 320.

Referring now to FIG. 4, further details of the photoreactive system 100 will now be discussed. In some embodiments, the light source 300 may be configured to operate under one condition, and to not operate under another condition. For example, referring now to FIG. 4, the light source 300 may be in electronic communication with and operated by a controller device 700. The controller device may be any electronic device that is capable of being programmed with instructions related to the operation of light source 300 and, in some embodiments, a fluid flow generator. The controller device 700 may be configured to receive an indication whether a condition is present. For example, the controller device 700 may be positioned in electrical communication with a sensor that provides an indication as to whether a door associated with the refrigeration system is open or closed. Often, it is desirous for the light source 300 to not emit light when the light may be observed by a person. This is due to a number of factors, including affecting the aesthetic appeal of the refrigerated volume as well as potential adverse health effects of repeated or prolonged exposure to intense UV radiation. As such, the controller device 700 may be configured to operate the light source 300 when the door is indicated to be closed, and to cease operation of the light source 300 when the door is indicated to be open. As an energy saving measure, the controller device 700 may further be configured to operate the fluid flow generator 600 according to the same method of operation.

Additionally, in some embodiments, the photoreactive system 100 may further include a sensor 710. The controller device 700 may be in electrical communication with the sensor 710. The sensor 710 may be configured to provide information regarding the environment of the refrigerated volume that the controller device 700 may operate the light source 300 responsive thereto. For example, the sensor 710 may be configured to detect the level of carbon dioxide in the environment of the refrigerated volume. The controller device 700 may be configured to maintain the carbon dioxide level of the environment of the refrigerated volume within a certain range. When the level indicated by the sensor 710 falls below the range, the controller device 700 may operate the light source 300, thereby generating carbon dioxide. Furthermore, when the level indicated by the sensor 710 exceeds the range, the controller device 700 may cease the operation of the light source 300. The example of a carbon dioxide sensor is exemplary only, and any other types of sensors are included within the scope of the invention.

As another example, the controller device 700 may be configured to maintain the level of a toxin, as described hereinabove, below a threshold level, and the sensor 710 may be configured to determine the level of the toxin within the refrigerated volume. When the level of the toxin indicated by the sensor 710 equals or exceeds the threshold level, the controller device 700 may operate the light source 300 to reduce the level of the toxin.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

That which is claimed is:

1. A photoreactive system comprising:
a body member including:
an outer wall;
an inner wall;
a proximal vented section;
a distal vented section;
a void between an inner surface of the outer wall and an outer surface of the inner wall defined as an outer chamber; and
a void defined by an inner surface of the inner wall defined as an inner chamber;
a light source configured to emit light within a wavelength range; and
a plurality of photoreactive pellets configured to react to the light emitted by the light source to remove at least one of bacteria, volatile organic compounds (VOCs), and ethylene;
wherein the plurality of photoreactive pellets are positioned within the outer chamber;
wherein the light source is positioned within the inner chamber; and
wherein the proximal and distal vented sections are configured to permit a gaseous flow therethrough, the gaseous flow including at least one of bacteria, VOCs, and ethylene.

2. The photoreactive system according to claim 1 wherein the light source is configured to emit light within a wavelength range from about 10 nm to about 400 nm.

3. The photoreactive system according to claim 1 wherein the plurality of photoreactive pellets includes pellets configured to react to light within a wavelength range of at least one of from about 320 nm to about 400 nm, from about 290 nm to about 320 nm, and from about 200 nm to about 290 nm.

4. The photoreactive system according to claim 1 wherein the plurality of photoreactive pellets includes pellets made from at least one of titanium dioxide and silicon dioxide.

5. The photoreactive system according to claim 1 wherein the plurality of photoreactive pellets includes a mixture of pellets formed of titanium dioxide and pellets formed of silicon dioxide.

6. The photoreactive system according to claim 5 wherein the photoreactive pellets formed of titanium dioxide are one of interspersed, segregated longitudinally, and segregated so as to form respective semicircles with the photoreactive pellets formed of silicon dioxide.

7. The photoreactive system according to claim 1 wherein the light source is generally coextensive with a length of the plurality of photoreactive pellets.

8. The photoreactive system according to claim 1 wherein the light source comprises a plurality of light-emitting diodes (LEDs).

9. The photoreactive system according to claim 8 wherein the plurality of LEDs are distributed so as to emit light in an approximately 360 degree distribution along the length of the light source.

10. The photoreactive system according to claim 1 further comprising a drain in fluid communication with the outer chamber.

11. The photoreactive system according to claim 1 further comprising a retaining member configured to retain the plurality of photoreactive pellets within the outer chamber.

12. The photoreactive system according to claim 1 further comprising a fluid flow generator positioned in fluid communication with the proximal vented section; wherein the fluid flow generator is positioned such that a fluid flow generated thereby causes a fluid flow through the outer chamber.

13. The photoreactive system according to claim 1 further comprising a sensor configured to provide information related to the environment within a refrigerated volume associated with the photoreactive system; wherein the light source comprises a controller device positioned in electrical communication with the sensor; and wherein the controller device is configured to control operation of the light source responsive to information received from the sensor.

14. The photoreactive system according to claim 13 wherein the plurality of photoreactive pellets includes pellets configured to react to light emitted by generating carbon dioxide; wherein the sensor is configured to provide information related to the level of carbon dioxide within the refrigerated volume; and wherein the controller device is configured to operate the light source to cause the generation of carbon dioxide responsive to the level of carbon dioxide indicated from the sensor.

15. A photoreactive system comprising:
a body member including:
an outer wall;
an inner wall;
a proximal vented section;
a distal vented section;
a void between an inner surface of the outer wall and an outer surface of the inner wall defined as an outer chamber; and
a void defined by an inner surface of the inner wall defined as an inner chamber;
a light source configured to emit light within a wavelength range and further comprising:
a plurality of LEDs; and
a controller device positioned in operational communication with the sensor plurality of LEDs;
an optic;
a sensor positioned in communication with the controller device and configured to provide information related to the environment within a refrigerated volume associated with the photoreactive system; and
a plurality of photoreactive pellets configured to react to the light emitted by the light source to remove at least one of bacteria, volatile organic compounds (VOCs), and ethylene;
wherein the plurality of photoreactive pellets are positioned within the outer chamber;
wherein the light source is positioned within the inner chamber;
wherein the proximal and distal vented sections are configured to permit a gaseous flow therethrough, the gaseous flow including at least one of bacteria, VOCs, and ethylene;
wherein the plurality of photoreactive pellets includes a mixture of pellets formed of titanium dioxide and pellets formed of silicon dioxide; and
wherein the controller device is configured to control operation of the light source responsive to information received from the sensor.

16. A photoreactive system comprising:
a light source configured to emit light within a wavelength range and comprising a plurality of LEDs; and
a plurality of photoreactive pellets configured to react to light emitted by the plurality of LEDs to remove at least one of bacteria, volatile organic compounds (VOCs), and ethylene;
a body member including:
an outer wall;
an inner wall formed of a transparent or translucent material;
a plurality of struts configured to carry the light source such that a longitudinal axis of the light source is approximately collinear with a longitudinal axis of the inner chamber;
a proximal vented section;
a distal vented section;
a void between an inner surface of the outer wall and an outer surface of the inner wall defined as an outer chamber; and
a void defined by an inner surface of the inner wall defined as an inner chamber;
wherein the plurality of photoreactive pellets are positioned within the outer chamber;
wherein the light source is positioned within the inner chamber;
wherein the proximal and distal vented sections are configured to permit a gaseous flow therethrough, the gaseous flow including at least one of bacteria, VOCs, and ethylene; and
wherein the plurality of LEDs are configured to emit light within a wavelength range from about 10 nm to about 400 nm.

17. The photoreactive system according to claim 16 further comprising a sensor configured to provide information related to the environment within a refrigerated volume associated with the photoreactive system; wherein the light source comprises a controller device positioned in electrical communication with the sensor; and wherein the controller device is configured to control operation of the light source responsive to information received from the sensor.

18. The photoreactive system according to claim 17 wherein the plurality of photoreactive pellets includes pellets configured to react to light emitted by the generate carbon dioxide; wherein the sensor is configured to provide information related to a level of carbon dioxide within the refrigerated volume; and wherein the controller device is configured to operate the light source to cause generation of carbon dioxide responsive to the level of carbon dioxide indicated from the sensor.

19. The photoreactive system according to claim 16 wherein the plurality of photoreactive pellets includes pellets made from at least one of titanium dioxide and silicon dioxide.

20. The photoreactive system according to claim 16 further comprising a fluid flow generator positioned in fluid communication with the proximal vented section; wherein the fluid flow generator is positioned such that a fluid flow generated thereby causes a fluid flow through the outer chamber.
